(19) United States
(12) Patent Application Publication
(10) Pub. No.: US 2007/0026118 A1
(43) Pub. Date: Feb. 1, 2007

(54) Nut brittle making method

(76) Inventor: Ernest D. Frump JR., Reynoldsburg, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/193,733

(22) Filed: Jul. 29, 2005

(51) Int. Cl. A47J 39/00

(52) U.S. Cl. 426/520

(57) ABSTRACT

An improved method for making a nut brittle candy begins by placing a plurality of ingredients in a heatable container to form a mixture and heating the container with a heat source. The next step is to remove the mixture from the heat source, pour the mixture into a flat tray, and spread the mixture into a thin layer. Furthermore, the method includes exposing the thin mixture layer to an elevated temperature in the range of about 175° F. to about 450° F. for a time sufficient to create micro-bubbles. The final step includes ceasing the exposure to the elevated temperature, thereby cooling, undisturbed, the thin mixture layer to about room temperature to form a brittle candy with micro-bubbles.

### (e) BACKGROUND OF THE INVENTION

1. Field of the Invention

This invention relates generally to making candy and more specifically an improved method for making nut brittle.

2. Description of the Related Art

Conventional methods used to create peanut brittle include the steps of combining ingredients in a container over a heat source and then pouring the hot mixture into a tray and spreading into a thin layer. The thin layer is then left to cool. The candy can be cooled either by placing the tray in a refrigerator or a freezer or by leaving the tray in a room temperature environment. After it has cooled, the candy is broken into small pieces for consumption.

The problem with conventional methods for producing this type of candy is that the conventional method produces a product that is very dense, hard and therefore, difficult to chew. An example of conventional peanut brittle is illustrated in FIG. 3. Traditional peanut brittle is more like a hard tack candy surrounding the nuts, and this portion of the peanut brittle is very dense. Many of the gas bubbles that are formed at the final mixing are lost or destroyed when the mixture is poured and spread thin to cool. This traditionally hard candy can be difficult for anyone to chew, but especially difficult for older individuals or those with sensitive teeth or bridgework, to eat and enjoy.

Also damaging to the quality of candy is high humidity, which should be considered when making candy.

Therefore, it is the object and feature of the invention to provide an improved method for creating a nut brittle candy that is easier to chew.

### (f) BRIEF SUMMARY OF THE INVENTION

The invention is an improved method for making a brittle candy that begins by placing a plurality of ingredients in a heatable container to form a mixture and exposing the container to a heat source. The next step is to remove the mixture from the heat source, pour the mixture into a flat tray, and spread the mixture into a thin layer. The next step of the method includes exposing the thin mixture layer to an elevated temperature in a range between about 175° F. and about 450° F. for a time sufficient to create micro-bubbles. The final step includes ceasing the exposure to the elevated temperature, thereby cooling the thin mixture layer to about room temperature to form a hardened brittle candy with micro-bubbles. Because of the porosity of the cooled and hardened candy, the product is much more easily chewed.

### (g) BRIEF DESCRIPTION OF THE SEVERAL VIEWS OF THE DRAWINGS

FIG. 1 is a view in perspective illustrating the preferred embodiment of the present method.

FIG. 2 is a view in perspective illustrating the embodiment of FIG. 1.

FIG. 3 is a perspective view illustrating a prior art brittle.

In describing the preferred embodiment of the invention, which is illustrated in the drawings, specific terminology will be resorted to for the sake of clarity. However, it is not intended that the invention is limited to the specific term so selected, and it is to be understood that each specific term includes all technical equivalents, which operate in a similar manner to accomplish a similar purpose.

### (h) DETAILED DESCRIPTION OF THE INVENTION

The method for making brittle candy begins by placing a plurality of ingredients in a heatable container or a saucepan, to form a mixture. The ingredients preferably include sugar, corn syrup, water, butter, baking soda, vanilla and peanuts. Depending upon the recipe used, some of the ingredients may be incorporated into the mixture at varying times, including after removing the mixture from the heat. For example, the butter, vanilla and baking soda may be stirred into the mixture after heating, but before spreading onto the tray. However, a person having ordinary skill in the art will recognize that any variety or combination of ingredients can be used. The above list is only one example that is used for peanut brittle. Other nuts can be used, for example, cashews.

The container with the mixture is then exposed to a heat source, usually a gas or electric stove top. Of course, any heat source can be utilized including microwaves, a grill, a campfire or an oven. While heating to a sufficient temperature, preferably about 290 degrees Fahrenheit, the user mixes the mixture and then removes the heatable container from the heat source once the temperature has reached the required level. All temperatures are in degrees Fahrenheit, unless noted otherwise.

After it is removed from the heat source, or if the entire process occurs within a heated environment, the heated mixture is poured onto a flat tray, for example a shallow cookie sheet, preferably one that has been greased. The mixture is spread into a thin layer across the tray's length and width. The flat tray can be any of a variety of structures including glass cookware, skillets, cookie sheets or any other large surface so long as a thin layer can be prepared.

Once the mixture is spread into a thin layer on the flat tray, it begins to cool due to its much larger surface area and its contact with the tray. In the next step, the user exposes the tray and the thin mixture to an elevated temperature in a range between about 175° F. and about 450° F. for a time sufficient to create micro-bubbles in the mixture. Preferably the elevated temperature is in the range of about 275° F. to about 320° F. and even more preferably, the elevated temperature is about 290° F. The micro-bubbles are formed in the mixture during undisturbed exposure to the elevated temperature and remain even after the mixture has cooled.

Exposing the tray and the thin mixture to an elevated temperature can be carried out in a variety of ways. For example, a radiant or microwave oven, a radiant or convection heater, a campfire, or a conveyor having various zones where heat is applied can all be used to elevate the temperature of the thin mixture. It is not critical what mechanism is used to elevate the temperature of the mixture, but the fact that its temperature is being raised evenly throughout the mixture while ascending to the elevated temperature.

The time the mixture must remain at the elevated temperature to create micro-bubbles is typically between about 1 minute and about 12 minutes for a temperature range of 175° F. to 450° F. For the temperature ranging from 275° F. to 320° F. the time ranges from about 1 minute to about 5 minutes. For the preferred temperature of about 290° F. the exposure time is about 3 minutes to create micro-bubbles. The time varies not only by temperature, but also by the means used to elevate the temperature, because of differences in the rate at which different means elevate the temperature.

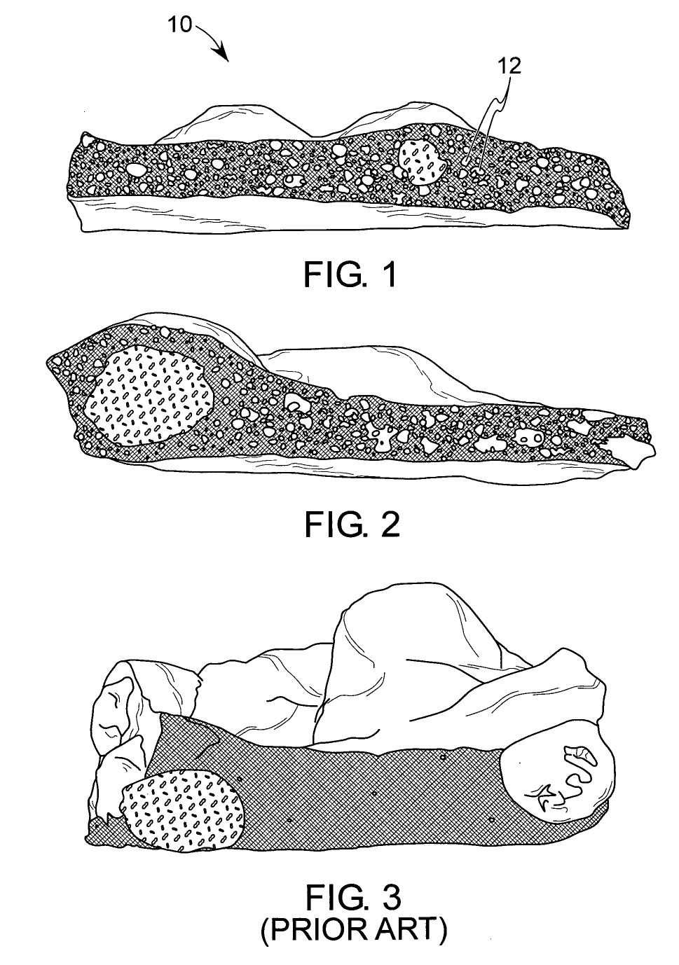

Once the thin layer has been exposed to the elevated temperature for a sufficient period, the user ceases the exposure of the tray and mixture to the elevated temperature and preferably places the mixture in a room temperature environment. This “cooling” of the mixture allows the mixture to harden by the time it reaches about room temperature. No mixing or mechanical disturbing of the mixture takes place between the ceasing of the exposure to the elevated temperature and the hardening of the candy, and therefore the candy 10 retains the micro-bubbles 12 after it has cooled and hardened. Once the brittle candy 10 is cooled, the user breaks the candy into bite-sized pieces, which are illustrated in FIGS. 1 and 2.

It is theorized that the micro-bubbles 12 are produced by a reaction that involves the baking soda in the mixture during exposure to the elevated temperature. This reaction creates micro-bubbles, which are pockets of gas that remain in the mixture even after it is cooled and hardened. It is important to form these micro-bubbles after the mixture is in a thin layer, so that the bubbles are not removed as with the prior step of mixing or pouring and spreading the mixture. The preferred hardened candy has a density of micro-bubbles similar to that illustrated in FIGS. 1 and 2. The micro-bubbles give the preferred hardened brittle candy a more porous consistency, which permits it to be crushed, and therefore chewed, more easily. These bubbles vary in size from at least 1/16^{th} of an inch down to much smaller fractions of an inch.

A density comparison between a candy prepared using a conventional method and the preferred candy with micro-bubbles was performed. The mass was measured and recorded, and the volume was found using a water displacement method. The volumes were recorded for each product. The density was then calculated from the recorded results of the volume and mass of each product.

The conventional method candy had a mass of about 32.28 grams, a volume of about 24.7 ml, and a density of about 1.31 g/ml. The preferred candy had a mass of about 22.87 grams, a volume of about 25 ml, and a density of about 0.915 g/ml. As illustrated in this test, the preferred candy is about two thirds of the density of the candy produced by the conventional method. This difference is due to the perseverance of bubbles in the candy that has displaced candy. A person having ordinary skill in the art will recognize that this is only one example of the difference in densities between the conventional method candy and the preferred method candy with micro-bubbles and that the results can vary significantly. Density varying from between about 50% and about 90% is also contemplated.

An alternative step to the preferred method is to deliberately allow the tray and thin mixture to cool for a specified amount of time and/or to a specified temperature followed by exposing the thin mixture layer to an elevated temperature sufficient to create micro-bubbles in the mixture. For example, the tray and thin mixture can cool for about 20 minutes and then be exposed to the elevated temperature for micro-bubble creation. Another alternative involves multiple re-heating and cooling steps after the mixture has been spread into a thin layer. After sufficient micro-bubbles are formed in the mixture, the exposure to elevated temperature is ceased, and the mixture cools to about room temperature when the candy can be broken into bite-sized pieces. A still further alternative involves stabilizing the heat during spreading of the mixture. While spreading the mixture onto the flat surface mechanically, heat is continuously applied so that the micro-bubbles will form. With this alternative, there is no reduction in heat of the mixture between initial heating of the ingredients and spreading of the mixture onto the tray.

The preferred brittle candy is much different from the peanut brittle candies currently on the market, which have more of a dense “hard tack” consistency. The preferred method produces a brittle candy that is easy to chew because of the micro-bubbles created in the mixture. Therefore, all nut brittle lovers can enjoy it without fear of losing a tooth or harming expensive bridgework.

While certain preferred embodiments of the present invention have been disclosed in detail, it is to be understood that various modifications may be adopted without departing from the spirit of the invention or scope of the following claims.

1. An improved method for making a brittle candy by placing a plurality of ingredients in a heatable container to form a mixture and heating the container with a heat source, then removing the mixture from the heat source and pouring the mixture into a flat tray for spreading the mixture into a thin layer, the improvement comprising:
(a) exposing the thin mixture layer to an elevated temperature in a range between about 175° F. and about 450° F. for a time sufficient to create micro-bubbles in the mixture; and
(b) ceasing the exposure to the elevated temperature to cool the thin mixture layer to about room temperature to form a brittle candy with micro-bubbles retained therein.

2. The improved method in accordance with claim 1, wherein the elevated temperature is within a range of about 275° F. to about 320° F.

3. The improved method in accordance with claim 2, wherein the elevated temperature is about 290° F.

4. The improved method in accordance with claim 1, wherein the time sufficient to create micro-bubbles is within a range of about 1 minute to about 12 minutes.

5. The improved method in accordance with claim 4, wherein the time sufficient to create micro-bubbles is within a range of about 1 minute to about 5 minutes.

6. The improved method in accordance with claim 5, wherein the time sufficient to create micro-bubbles is about 3 minutes.

7. An improved method for making a brittle candy by placing a plurality of ingredients in a heatable container to form a mixture and heating the container with a heat source, then removing the mixture from the heat source, pouring the mixture into a flat tray and spreading the mixture into a thin layer on the tray, the improvement comprising:
(a) heating an oven to a temperature between about 175° F. and about 450° F.;
(b) inserting the flat tray and the thin mixture layer into the oven for a time sufficient to create micro-bubbles; and
(c) removing the flat tray from the oven to cool the mixture to about room temperature to form a brittle candy with micro-bubbles.

8. The improved method in accordance with claim 7, wherein the elevated temperature is within a range of about 275° F. to about 320° F.

9. The improved method in accordance with claim 8, wherein the elevated temperature is about 290° F.

10. The improved method in accordance with claim 7, wherein the time sufficient to create micro-bubbles is within a range of about 1 minute to about 12 minutes.

11. The improved method in accordance with claim 10, wherein the time sufficient to create micro-bubbles is within a range of about 1 minute to about 5 minutes.

12. The improved method in accordance with claim 11, wherein the time sufficient to create micro-bubbles is about 3 minutes.

13. An improved method for making a nut brittle candy by placing a plurality of ingredients in a heatable container to form a mixture and heating the container with a heat source, then removing the mixture from the heat source, pouring the mixture into a flat tray and spreading the mixture into a thin layer on the tray, the improvement comprising:
(a) heating an oven to a temperature of about 290° F.;
(b) turning off the oven;
(c) inserting the flat tray and the thin mixture layer into the oven and heating for about 3 minutes to create micro-bubbles; and
(d) removing the flat tray from the oven to cool the mixture to about room temperature to form a nut brittle candy with micro-bubbles and breaking the nut brittle candy into bite-sized pieces.
